(19) United States
(12) Patent Application Publication
(10) Pub. No.: US 2017/0089130 A1
(43) Pub. Date: Mar. 30, 2017

(54) CORD LOCK OF WINDOW COVERING

(71) Applicant: NIEN MADE ENTERPRISE CO., LTD., Taichung City (TW)

(72) Inventor: Chih-Yao CHANG, Taichung City (TW)

(21) Appl. No.: 15/262,911

(22) Filed: Sep. 12, 2016

(30) Foreign Application Priority Data
Sep. 28, 2015 (CN) 201520755679.5

(51) Int. Cl. E06B 9/324

(52) U.S. Cl. CPC E06B 9/324

(57) ABSTRACT

A cord lock is disclosed, which is provided in a headrail of a window covering, and is adapted to be passed through by cords which are used to raise or lower the window covering. The cord lock is controllable to hold the cord to fix the window covering in a certain use condition. The cord lock is also controllable to release the cords, so that the cords could be pulled to raise or lower the window covering. The cord lock further includes a guiding member, which has at least one groove to receive the cords in a way that the cords are prevented from falling out of the groove. A number of the groove could be determined depending on a number of the cords, with the same number of cords arranged in each of the grooves, to prevent the cords from twisting.

### BACKGROUND OF THE INVENTION

1. Technical Field

The present invention relates generally to the structure of a window covering, and more particularly to a cord lock of a window covering, which could reduce the friction and prevent the cords from twisting.

2. Description of Related Art

A conventional window covering is raised and lowered with a plurality of cords. Typically, a cord lock is provided in a headrail of such a window covering, and the cords pass through the cord lock to be held or released, whereby the window covering can be operated accordingly to provide a required shading effect.

However, the cords and some components of the cord lock might be worn and torn due to the friction which might be created between the cords and the components of the cord lock during operation, for the cords and part of the components of the cord lock always contact with each other. Moreover, such friction would make the operation more difficult. Furthermore, the cords would be likely to overlap or twist with each other at the entrance or the exit of the cord lock, which unnecessarily brings difficulty and inconvenience for the operation. Especially if the cord lock is provided in the headrail in a tilted manner, the cords would get overlapped or twisted even more easily at the entrance of the cord lock due to the effects of gravity.

### BRIEF SUMMARY OF THE INVENTION

In view of the above, the primary objective of the present invention is to provide a cord lock, which could prevent the cords from twisting and reduce the friction between the cord and the cord lock.

The present invention provides a cord lock, which is provided in a headrail of a window covering, and is adapted to fix a position of a cord of the window covering, wherein the cord lock includes a housing, a braking module, and a guiding member. The housing has a chamber therein, and a toothed surface provided on a wall of the chamber, wherein the housing has a first side opening and a second side opening. The first side opening and the second side opening communicate with the chamber. The braking module is provided in the chamber of the housing, wherein the braking module comprises a guiding block and a braking gear. A channel is formed between the guiding block and the toothed surface. The braking gear is located in the channel, and optionally meshes with the toothed surface. The guiding member is provided on the housing, and is near the first side opening, wherein the guiding member has at least one groove. Whereby, two ends of the cord respectively pass through the first side opening and the second side opening of the housing. A part of the cord passes through a space between the guiding block and the braking gear, while another part of the cord is arranged in the at least one groove of the guiding member.

In an embodiment, the braking module comprises an abrasion resistant member. One end of the abrasion resistant member is connected to the guiding block, while another end of the abrasion resistant member bulges toward the toothed surface. A surface of the abrasion resistant member abuts against the cord.

In an embodiment, the guiding member comprises a wheel with the at least one groove recessed into a surface of the wheel.

In an embodiment, the guiding member comprises a plurality of wheels. Each of the at least one groove is recessed into a surface of one of the wheels.

In an embodiment, at least one dividing member is provided on the housing, and is near the second side opening, wherein each of the at least one dividing member comprises a shaft and a sleeve. The sleeve rotatably fits around the corresponding shaft.

In an embodiment, an arranging member is provided on the housing, and includes a top bar near the guiding member. The cord passes through a distance between the top bar and the guiding member.

In an embodiment, the arranging member further includes two lateral bars. The lateral bars are erectly provided on the housing, and are located outside of the first side opening. The cord passes through a space between the lateral bars.

In an embodiment, a depth of the at least one groove is greater than or equal to one-third of a diameter of the cord.

In an embodiment, the top bar and the lateral bars are integrally made.

With the design of above, the cord lock could prevent the cords from twisting and reduce the friction between the cords and the cord lock.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view, showing the cords and the cord lock of a first embodiment of the present invention;

FIG. 2 is a left side view of FIG. 1;

FIG. 3 is a sectional view of FIG. 1;

FIG. 4 is a front view of FIG. 3, showing the cords are held;

FIG. 5 is another front view of FIG. 3, showing the cords are released;

FIG. 6 is a perspective view, showing the cords and the cord lock of a second embodiment of the present invention; and

FIG. 7 is a left side view of FIG. 6;

### DETAILED DESCRIPTION OF THE INVENTION

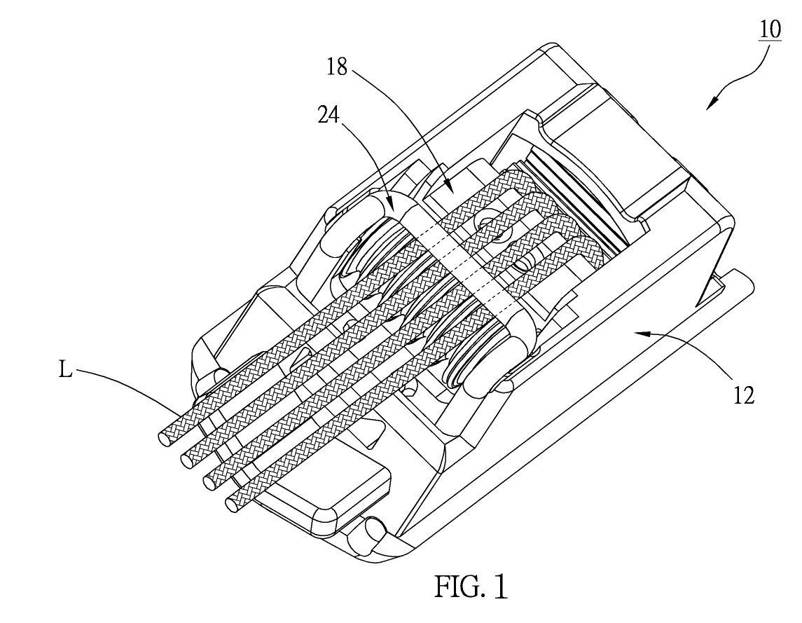

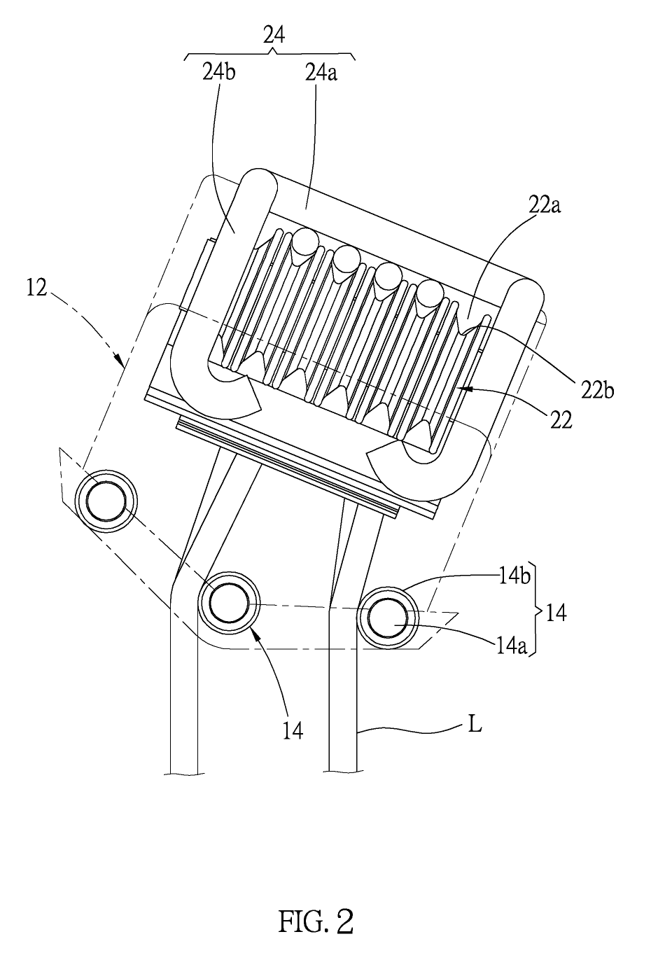

A cord lock 10 of a first embodiment of the present invention is illustrated in FIG. 1 to FIG. 3, which is provided in a headrail (not shown) of a window covering in a tilted manner, and is adapted to be passed through by a plurality of cords L, wherein the cord lock 10 could hold or release the cords L. When the cord lock 10 holds the cords L, the cords L could be fixed to maintain the window covering in a certain use condition; when the cord lock 10 releases the cords L, the cords L could be pulled to raise or lower the window covering.

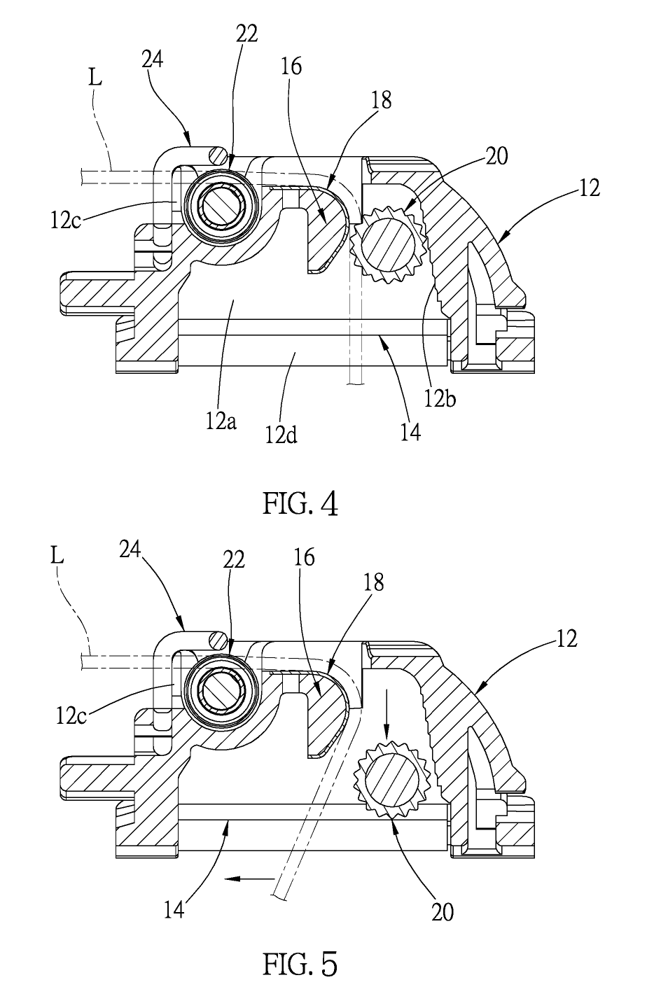

The cord lock 10 of the first embodiment includes a housing 12, at least one dividing member 14, a braking module, a guiding member 22, and an arranging member 24. As shown in FIG. 4, the housing 12 has a chamber 12a, wherein a toothed surface 12b is provided on a wall of the chamber 12a. The housing 12 further has a first side opening 12c and a second side opening 12d, wherein the first side opening 12c is formed on a lateral side of the housing 12, while the second side opening 12d is formed on a bottom surface of the housing 12. The first side opening 12c and the second side opening 12d communicate with the chamber 12a.

The at least one dividing member 14 includes three dividing members 14 in the first embodiment. Each dividing member 14 includes a shaft 14a and a sleeve 14b. Each shaft 14a is connected to the housing 12, and is horizontally provided near the second side opening 12d, while each sleeve 14b fits around the corresponding shaft 14a. Each sleeve 14b could rotate around the corresponding shaft 14a.

The braking module is provided in the chamber 12a of the housing 12, wherein the braking module includes a guiding block 16, an abrasion resistant member 18, and a braking gear 20. One end of the guiding block 16 is connected to an inner wall of the housing 12 (i.e., the wall of the chamber 12a), while another end thereof extends toward the toothed surface 12b. In the first embodiment, the guiding block 16 and the housing 12 are integrally made, and there is a channel formed between the guiding block 16 and the toothed surface 12b. The abrasion resistant member 18 is a slice with a smooth surface, wherein one end of the abrasion resistant member 18 is connected to the guiding block 16, while another end thereof bulges toward the toothed surface 12b. In the first embodiment, the guiding block 16 is covered with the abrasion resistant member 18 , and the smooth surface of the abrasion resistant member 18 abuts against the cords L. The braking gear 20 is located in the channel, and is confined by a top of the housing 12 and the dividing members 14. A surface of the braking gear 20 is toothed, which could optionally mesh with the toothed surface 12b.

Preferably, the guiding member 22 is composed of a plurality wheels, wherein the wheels are rotatably pivoted on the housing 12, and are near the first side opening 12c. In the first embodiment, a groove 22a is provided on each surface of the wheels along a circumferential direction, and the most recessed part of the groove 22a is defined as a bottom 22b.

The arranging member 24 is provided on the housing 12, and is located on one side of the guiding member 22, which is opposite to the guiding block 16. In the first embodiment, the arranging member 24 includes a top bar 24a and two lateral bars 24b, which are integrally made. The top bar 24a is connected to a top edge of each of the lateral bars 24b, and extends forward to be provided above and across the guiding member 22, wherein the top bar 24a is apart from the guiding member 22 by a distance, while the lateral bars 24b are erectly provided outside the first side opening 12c. In the first embodiment, a depth of each of the grooves 22a (i.e., a vertical distance between the bottom 22b and the surface of the relevant wheel) is greater than or equal to one-third of a diameter of the corresponding cord L, whereby the cords L would be prevented from falling out of the corresponding groove 22a. Therefore, the cords L would not be twisted. Also, a distance between the top bar 24a and the bottom 22b of each of the grooves 22a is only slightly greater than the diameter of the cords L.

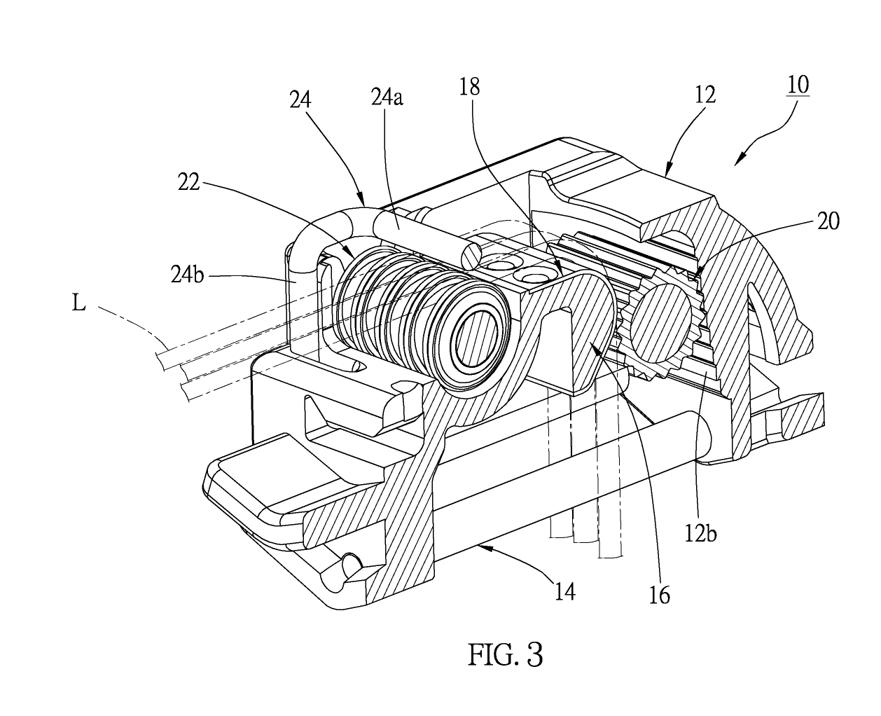

As shown in FIG. 3, the cords L include four cords L in the first embodiment, wherein the cords L pass through the cord lock 10, and two ends of each of the cords L respectively extend out of the housing 12 through the first side opening 12c and the second side opening 12d. One of the ends of each of the cords L is connected to a bottom rail (not shown) of the window covering, while the other one of the ends is adapted to be operated by pulling. In more details, each of the cords L is correspondingly arranged in one of the grooves 22a of the wheel, respectively, so that each of the cords L passes through the distance between the top bar 24a and the guiding member 22, and also passes through a space between the lateral bars 24b to leave the housing 12 through the first side opening 12c. A part of each of the cords L passes through a space between the guiding block 16 and the braking gear 20. Furthermore, two gaps are formed by the three dividing members 14, wherein the cords L are divided into two groups and correspondingly distributed in the gaps.

The braking gear 20, which is located on a top edge of the toothed surface 12b, is illustrated in FIG. 4. The cords L are held by the braking gear 20 and the abrasion resistant member 18, whereby the cords are fixed to maintain the window covering in a certain use condition. As shown in FIG. 5, when the cords L are shifted in a lateral direction, the braking gear 20 would drop due to the effect of gravity. As a result, the window covering could be raised by pulling down the cords L, and could be lowered with its own weight by releasing the cords L.

In summary, the cords L would not get twisted while being pulled, for a part of each of the cords L near the first side opening 12c is arranged in the corresponding groove 22a. In addition, each wheel of the guiding member 22 could rotate respectively, so that the cords L would not interfere with each other even if the cords L are not operated evenly. Whereby, the cords L could be ensured to be wound up or released smoothly.

In practice, the guiding member 22 could be composed of one single wheel, wherein a plurality of smooth grooves 22a are recessed into a surface of said wheel. In this way, the cords L could also be prevented from twisting around each other, for each of the cords L is separated from others. The smooth surface of each of the grooves 22a would also help the cords L to move smoothly even if the cords L are operated with irregular force.

In addition, the top bar 24a of the arranging member 24 is close to the guiding member 22, which could prevent the cords L from falling out of the corresponding groove 22a. Furthermore, since the cord lock 10 is provided in the headrail in a tilted manner, the cords L would abut against the rotatable sleeve 14b of the dividing member 14 at where they pass through the second side opening 12d, whereby the friction between the cords L and the cord lock 14 could be reduced. The abrasion resistant member 18 and the lateral bars 24b of the arranging member 24 could also help to reduce the friction between the cords L and the cord lock 14.

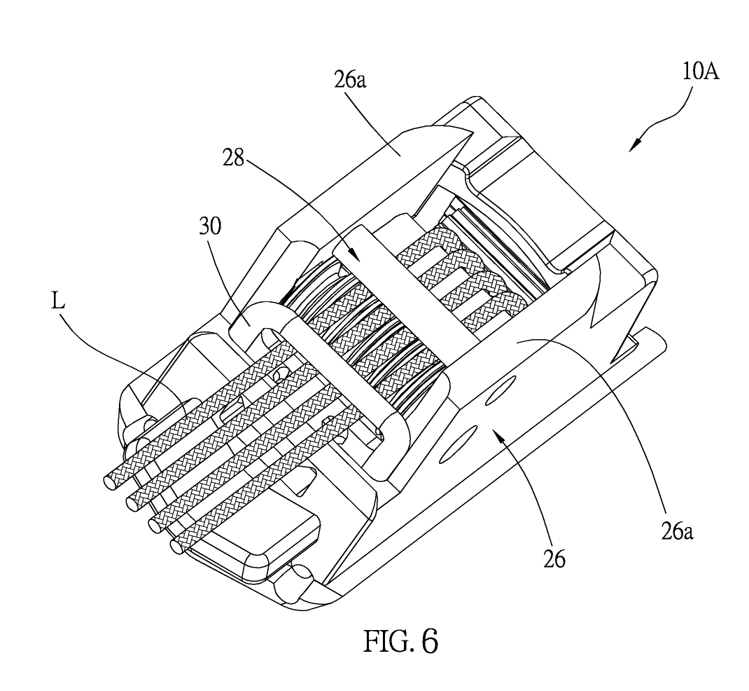

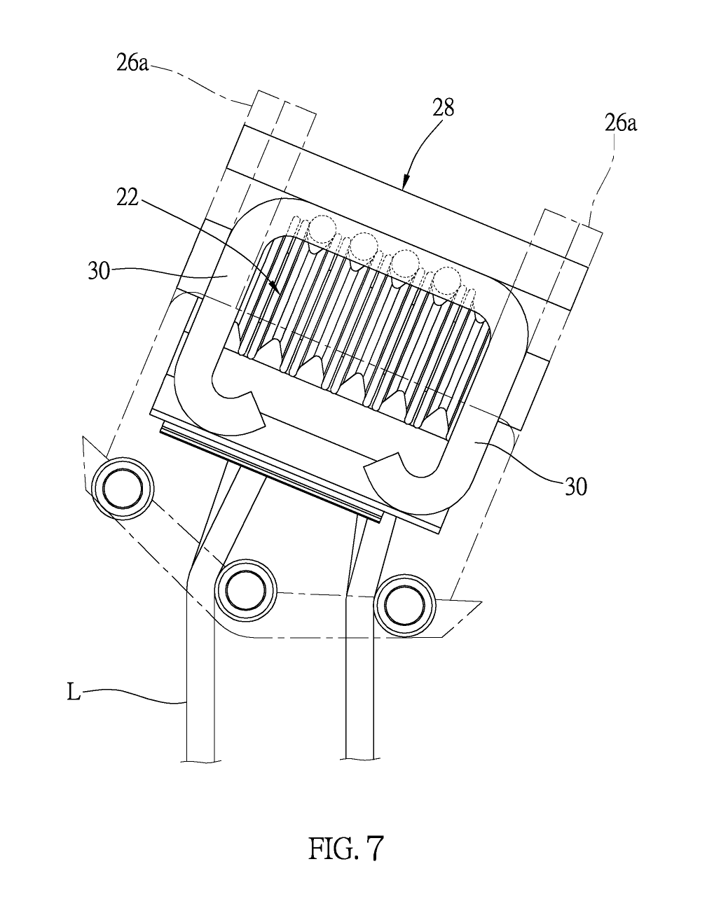

A cord lock 10A of a second embodiment of the present invention is illustrated in FIG. 6 and FIG. 7, wherein the cord lock 10A includes the dividing member, the braking module, and the guiding member as mentioned in the first embodiment. The difference between the cord lock 10A of the second embodiment and that of the first embodiment is that, a housing 26 of the cord lock 10A of the second embodiment has two side walls 26a, and the arranging member, which has a top bar 28 and two lateral bars 30, is not integrally made. Two ends of the top bar 28 are respectively connected to the side walls 26a, and are located above the guiding member 22. A U-shaped member is connected to the outside of the first side opening 12c, wherein the lateral bars 30 are part of the U-shaped member. Said top bar 28 is adapted to prevent the cords from falling out of the corresponding groove. The lateral bars 30 could restrict a moving range of the cords L and reduce the friction between the cords L and the cord lock 10A as well.

It must be pointed out that the embodiments described above are only some preferred embodiments of the present invention. All equivalent structures which employ the concepts disclosed in this specification and the appended claims should fall within the scope of the present invention.

What is claimed is:

1. A cord lock, which is provided in a headrail of a window covering, and is adapted to fix a position of a cord of the window covering; comprising:
a housing, which has a chamber therein, and a toothed surface provided on a wall of the chamber, wherein the housing has a first side opening and a second side opening; the first side opening and the second side opening communicate with the chamber;
a braking module, which is provided in the chamber of the housing, wherein the braking module comprises a guiding block and a braking gear; a channel is formed between the guiding block and the toothed surface; the braking gear is located in the channel, and optionally meshes with the toothed surface; and
a guiding member, which is provided on the housing, and is near the first side opening, wherein the guiding member has at least one groove;
whereby, two ends of the cord respectively pass through the first side opening and the second side opening of the housing; a part of the cord passes through a space between the guiding block and the braking gear, while another part of the cord is arranged in the at least one groove of the guiding member.

2. The cord lock of claim 1, wherein the braking module comprises an abrasion resistant member; one end of the abrasion resistant member is connected to the guiding block, while another end of the abrasion resistant member bulges toward the toothed surface; a surface of the abrasion resistant member abuts against the cord.

3. The cord lock of claim 1, wherein the guiding member comprises a wheel with the at least one groove recessed into a surface of the wheel.

4. The cord lock of claim 1, wherein the guiding member comprises a plurality of wheels; each of the at least one groove is recessed into a surface of one of the wheels.

5. The cord lock of claim 1, further comprising at least one dividing member, which is provided on the housing, and is near the second side opening, wherein each of the at least one dividing member comprises a shaft and a sleeve; the sleeve rotatably fits around the corresponding shaft.

6. The cord lock of claim 1, further comprising an arranging member, wherein the arranging member is provided on the housing, and comprises a top bar near the guiding member; the cord passes through a distance between the top bar and the guiding member.

7. The cord lock of claim 6, wherein the arranging member further comprises two lateral bars; the lateral bars are erectly provided on the housing, and are located outside of the first side opening; the cord passes through a space between the lateral bars.

8. The cord lock of claim 6, wherein a depth of the at least one groove is greater than or equal to one-third of a diameter of the cord.

9. The cord lock of claim 7, wherein the top bar and the lateral bars are integrally made.
